(19) United States
(12) Patent Application Publication
(10) Pub. No.: US 2014/0095316 A1
(43) Pub. Date: Apr. 3, 2014

(54) MOBILE ADVERTISING SYSTEM AND METHOD

(71) Applicants: Majdi YASIN, Amman (JO); Samer ZUREIKAT, Wolfstein (DE)

(72) Inventors: Majdi YASIN, Amman (JO); Samer ZUREIKAT, Wolfstein (DE)

(21) Appl. No.: 14/040,869

(22) Filed: Sep. 30, 2013

Related U.S. Application Data
(60) Provisional application No. 61/708,269, filed on Oct. 1, 2012.

(51) Int. Cl. G06Q 30/02

(52) U.S. Cl. CPC G06Q 30/0267
USPC 705/14.64

(57) ABSTRACT

The present disclosure generally relates to an application for displaying advertisements. The application resides on a mobile device or an electronic device with mobile networking capability and is in communication with a user database mediation server and an advertisement inventory server. The application and associated servers are adapted to acquire users' permission to automatically display advertisements on the incoming call screen of their electronic device, connect users who wish to view advertisements on their electronic device whenever they receive a call from one another, download an advertisement to a contact image record of a users' electronic device address book, display a contact record, and credit users for the calls that they place to other users which result in the display of an advertisement on the other user's electronic device. Related systems and methods are described.

### CROSS-REFERENCE TO RELATED APPLICATIONS

This application claims priority to U.S. Provisional Patent Application No. 61/708,269, filed on Oct. 1, 2012, the disclosure of which is hereby incorporated by reference in its entirety.

### BACKGROUND

Commercial broadcasting, such as radio and television, has relied on the appeal of its content to generate its revenues, whether through paid subscriptions or sponsorship by advertisers. The growing popularity of Internet-enabled social media platforms has made it possible for creators of compelling original content to reach a wide audience, almost rivaling the reach of traditional broadcast media. This fact has allowed social media companies to attract advertisers to advertise on their platforms. Nonetheless, broadcasting, especially television, still maintains an advantage over the newly established social networking model, as reflected in the premium paid by advertisers for television advertising. This advantage is most evident when it comes to the televised broadcasting of unique, live events such as the Super Bowl or the Academy Awards ceremony. The appeal of live events can be attributed to the perceived benefit of synchronous content consumption in such situations, whether it is the competition for the coveted title of Super Bowl champion, or the announcement of the winner of the Best Picture award.

On a smaller, yet equally compelling, scale, a phone call from a close friend or family member is also a live event, the perceived benefit of which can be found in the synchronous consumption of its content. By answering an incoming call, we are consuming original content from content creators who appeal to us. Moreover, a phone call is a form of two-way broadcasting, where we are not only the consumers of content, but also participating creators in the process. Improvements in video telephony, especially on smartphones and other devices with mobile networking capabilities, promises to further enhance the experience of communicating with friends and family.

Several attempts have been made to monetize on the captivating appeal of telephone calls. Previous efforts have met with limited success, as they have attempted to inject a traditional advertising model into the private sphere of interpersonal phone contact.

### SUMMARY

The present disclosure generally relates to an application for displaying advertisements. The application resides on a mobile device or an electronic device with mobile networking capability and is in communication with a user database mediation server and an advertisement inventory server. The application and associated servers are adapted to acquire users' permission to automatically display advertisements on the incoming call screen of their electronic device, connect users who wish to view advertisements on their electronic device whenever they receive a call from one another, download an advertisement to a contact image record of a users' electronic device address book, display a contact record, and credit users for the calls that they place to other users which result in the display of an advertisement on the other user's electronic device. The key to successful advertising on mobile phones can be distilled into two basic principles: embedding the message in the primary user experience, and rewarding users for their participation (after all, they are the creators of the content upon which the ads are being sold). Related systems and methods are described.

### DESCRIPTION OF THE DRAWINGS

Reference is now made to the following descriptions taken in conjunction with the accompanying drawings.

FIG. 1 illustrates a mobile advertising system according to one aspect of the present disclosure;

FIG. 2 illustrates an exemplary network architecture for implementing the mobile advertising system;

FIGS. 3A-3H illustrate exemplary call notification screens associated with the mobile advertising system;

FIG. 4 illustrates an exemplary process for performing initial installation of an application associated with the mobile advertising system;

FIG. 5 illustrates an exemplary process for uploading advertisements to the mobile advertising system;

FIG. 6 illustrates an exemplary process for launching an application after it has been initially installed; and

FIG. 7 illustrates an exemplary dialing process for use with the mobile advertising system.

### DETAILED DESCRIPTION

Various embodiments of a mobile application for connecting users who wish to receive advertisements on their mobile device and/or other electronic devices according to the present disclosure are described. It is to be understood, however, that the following explanation is merely exemplary in describing the devices and methods of the present disclosure. Accordingly, several modifications, changes and substitutions are contemplated.

The present disclosure generally relates to a mobile advertising system, which includes a mobile application (referred to herein as “my.ad”) that connects mobile device users who wish to receive advertisements on their mobile and/or other electronic devices. The system includes the front-end mobile device application connected to a back-end server engine. The mobile device application manages users' connections with each other, tracks users' engagement with the application, and communicates relevant usage information to the server. The server engine manages the distribution of advertisements to users' mobile devices, tracks advertisers' performance across users, and reconciles advertisement transactions between advertisers and users.

The application functions by transmitting advertisements to a user's mobile device using the device's operating system functionality or other applications installed on the device. In this example, the application downloads advertisements to the profile image records typically located in the default address book on a user's mobile phone, tablet, or device with mobile networking capability. When users place calls to other my.ad users, advertisements are displayed on the incoming call screen of the user's mobile phone, tablet, or device with mobile networking capability using the standard incoming call handling protocol on users' devices. Alternatively, the incoming call screen could be displayed on another device where the call can be answered, such as a television or display with mobile networking capability. The application also includes an account management system that allocates advertising revenues to my.ad users based on their level of engagement with other users on the application.

By downloading the app onto their mobile device and/or a device with mobile networking capability and accepting the my.ad terms of service, if applicable, users agree to allow the app to download advertisements to their devices. In this example, my.ad functions by downloading advertising inventory to the contact image record in the phone's address book. The user placing a call to another my.ad user may be eligible for a predetermined share of the revenue generated from advertisers as a result. Rewarding users, as well as charging advertisers, for advertisements served can be done using the device's operating system functionality or other applications installed on the mobile device or the device with mobile networking capability. In this example, in order to qualify for a share of advertising revenue, users may place calls to other my.ad users through the application.

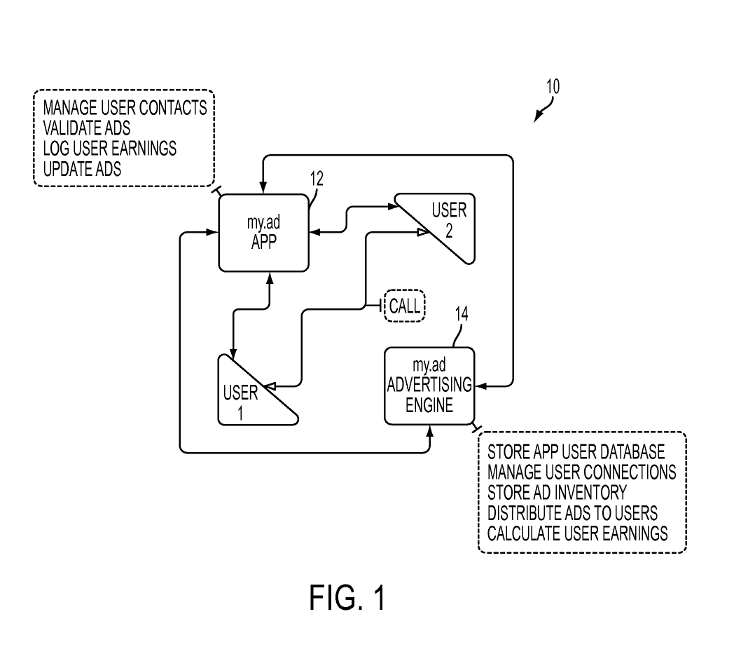

In some embodiments, and with reference to FIG. 1, a mobile advertising system 10 according to the present disclosure includes a smartphone application 12 (the “app”) operatively connected to a server running the advertising management system (the “engine”) 14. The app 12 may utilize the mobile device's operating system functionality or other applications installed on the device. In this example, the app utilizes the “address book” and “phone” Application Programming Interface (API) on mobile devices running either Apple's iOS, Google's Android, Microsoft's Windows Phone, Research in Motion's BlackBerry OS, or another operating system.

The app 12 may perform some or all of the following functions:
1. find and select contacts with whom to connect;
2. reconcile the selected contacts with app user records (“Contacts”) existing on the engine;
3. send connection requests to selected contacts;
4. download advertisements to Contacts' profile pictures in the user's address book;
5. store advertisements in Contacts' profile pictures on the user's phone;
6. display advertisements stored in Contacts' profile pictures on the user's phone in a browsable and linkable fashion;
7. provide users with further information relating to advertisements displayed;
8. maintain a log of changes to Contacts' profile pictures undertaken outside of the app;
9. communicate the “changes log” to the engine;
10. maintain a my.ad Contacts List;
11. dial Contacts' phone numbers;
12. confirm that dialed calls have been received;
13. maintain an Activity Log of calls made using the app;
14. communicate the Activity Log to the engine; and
15. maintain a log of communications between the app and the engine which is viewable by the user.

In turn, the ad engine 14 may perform some or all of the following functions:
1. maintain a database of advertisements to be downloaded to users' mobile phones;
2. allocate advertisements to my.ad users based on engine settings;
3. download advertisements to the app on users' phones;
4. process “changes log” received from the app;
5. manage changes to Contacts' profile pictures undertaken outside of the app;
6. process the Activity Log received from the app; and
7. credit, store, and maintain user accounts based on the Activity Log.

The foregoing disclosure may be implemented as an application on an electronic device. The electronic device according to the present disclosure may be any device with mobile networking capability (e.g., cellular, VOIP, WiFi, Bluetooth, near field communication), such as a hand-held, portable electronic device, a mobile telephone, a gaming device, a digital media player, a personal email device, a personal data assistant, a digital camera, or an electronic device combining one or more of the foregoing functions. In other embodiments, the electronic device can include a larger portable device such as a laptop computer, or tablet-type computing device (e.g., an iPad™ made available by Apple Inc. of Cupertino, Calif.). In still further embodiments, the principles of the present disclosure may be implemented on larger electronic devices, such as desktop computers or televisions.

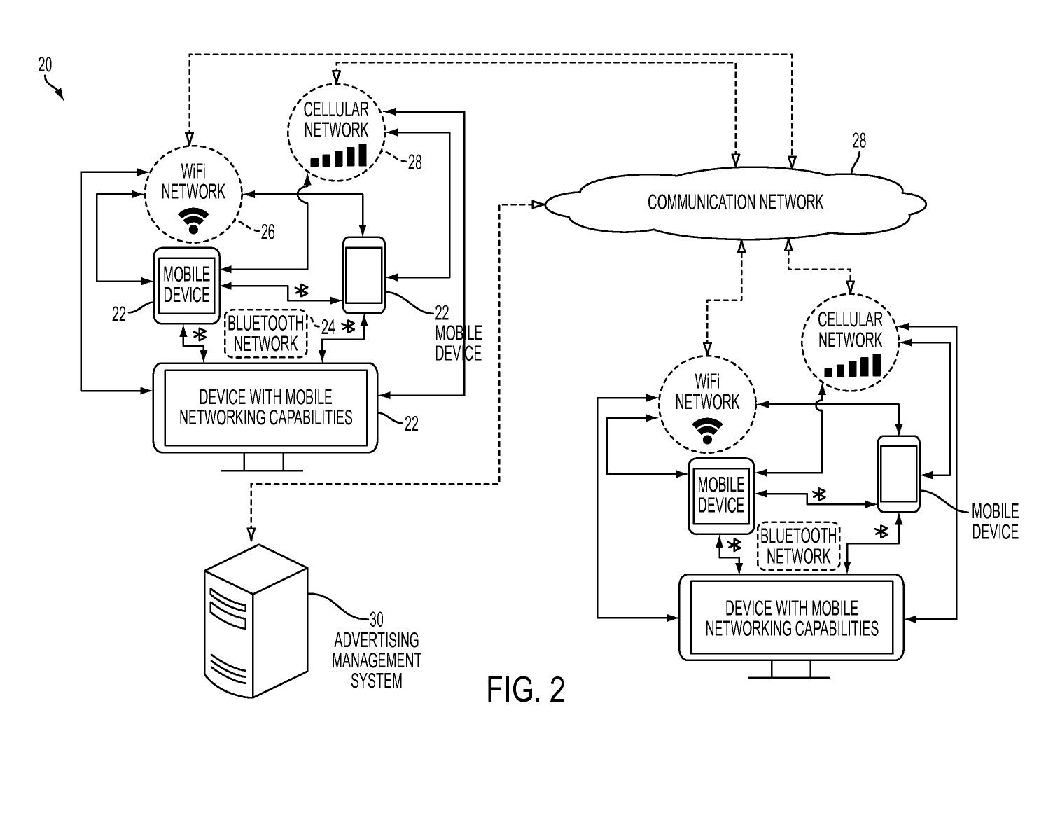

Referring to FIG. 2, an exemplary network architecture 20 is illustrated in which several electronic devices 22 (e.g., mobile devices such as phones and tablets, or devices with mobile networking capabilities such as televisions and displays) having the app 12 may be interconnected to facilitate the principles of the present disclosure. The electronic devices 22 may be connected using Wi-Fi, Bluetooth, near field communication, radio frequencies, infrared, GSM, CDMA, or other suitable protocols. In FIG. 2, the electronic devices 22 are connected to a Bluetooth network 24, a WiFi network 26 and a cellular network 28. However, it is to be appreciated that other embodiments are contemplated in which perhaps just one or two of such networks are utilized. The Bluetooth, WiFi and/or cellular networks 22, 24, and 26, respectively, facilitate connection of the electronic devices 22 to each other and to a communication network 28, such as the Internet. An advertising management system 30 is also connected to the communication network. The advertising management system 30 may be housed on a server to provide functionality such as storing advertisement inventory, distributing advertisements to users' electronic device applications and calculating user earnings.

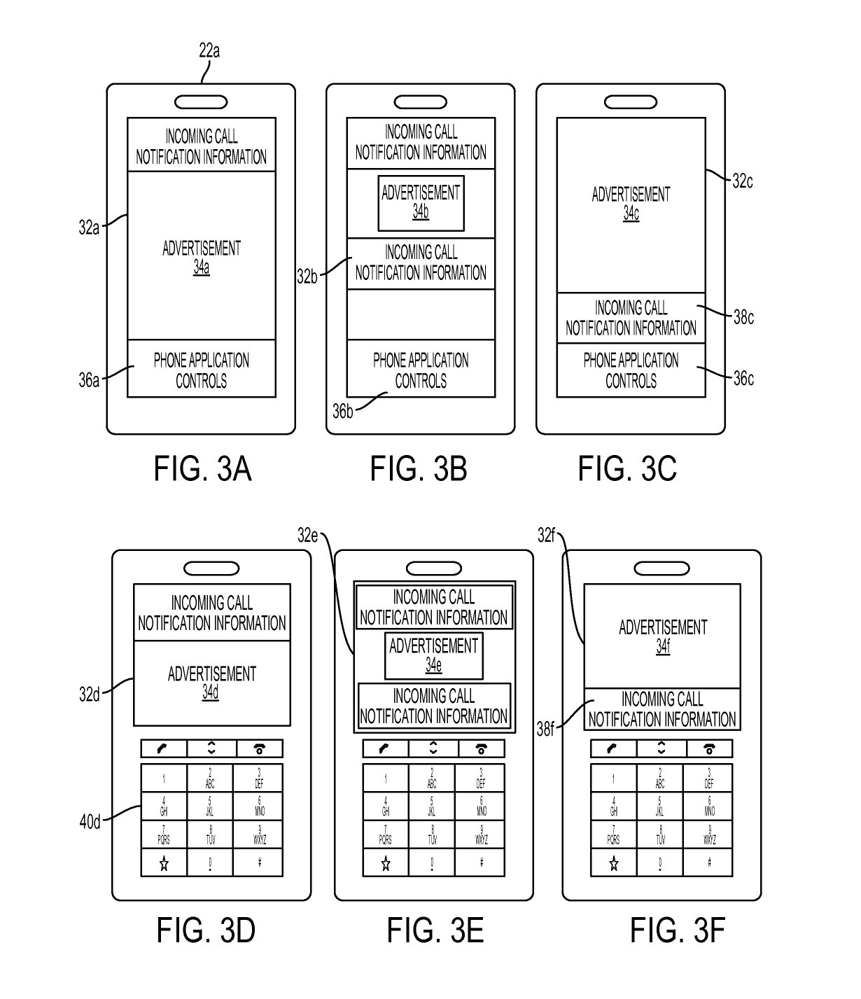

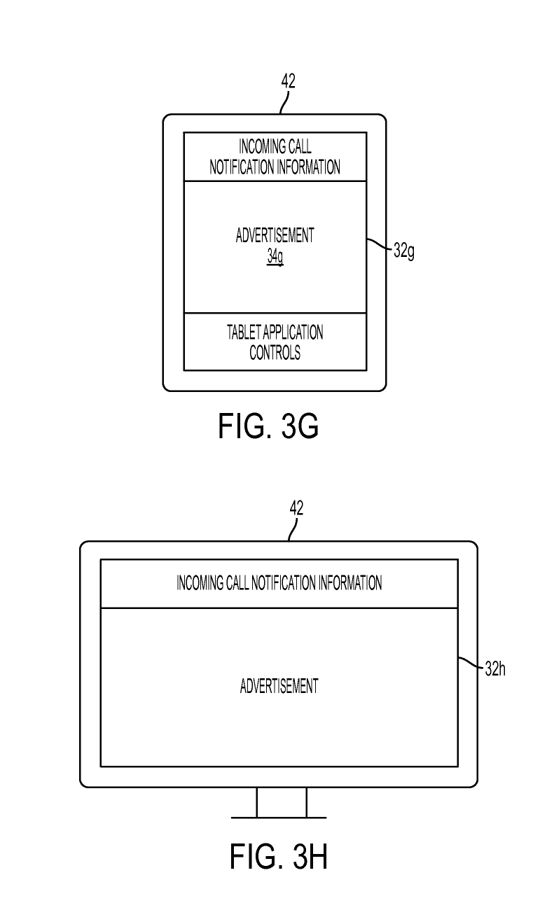

When a call is placed through the my.ad app 12, an advertisement may be presented to the call recipient according to a variety of call notification screens, some of which are shown in FIGS. 3A-3H. FIG. 3A illustrates a notification screen 32a in which an advertisement 34a occupies a majority of the screen on a phone 22a with touch controls 36a. FIG. 3B illustrates a notification screen 32b having a reduced size advertisement 34b relative to the advertisement shown in in FIG. 3A along with touch controls 36b. FIG. 3C illustrates an embodiment in which an advertisement 34c occupies a majority of a notification screen 32c with incoming call notification information 38c being provided at a bottom of the screen along with phone application controls 36c. FIG. 3D illustrates a notification screen 32d on a “feature phone” or smartphone with physical buttons and keys 40d in which an advertisement 34d occupies the majority of the screen. FIG. 3E illustrates a notification screen 32e having a reduced size advertisement 34e relative to the advertisement shown in FIG. 2d. FIG. 3F illustrates an embodiment in which an advertisement 34f occupies a majority of a notification screen 32f with incoming call notification information 38f being provided at a bottom of the screen. FIG. 3G illustrates a notification screen 32g on a tablet device 42 in which an advertisement 34g occupies a majority of the screen. FIG. 3H illustrates an incoming call notification screen 32h on a television 42 or display with mobile networking capabilities.

Having generally discussed the network architecture and presentation of advertisements associated with the mobile advertising system and method of the present disclosure, attention is now directed to exemplary algorithms or processes for implementing such system and method.

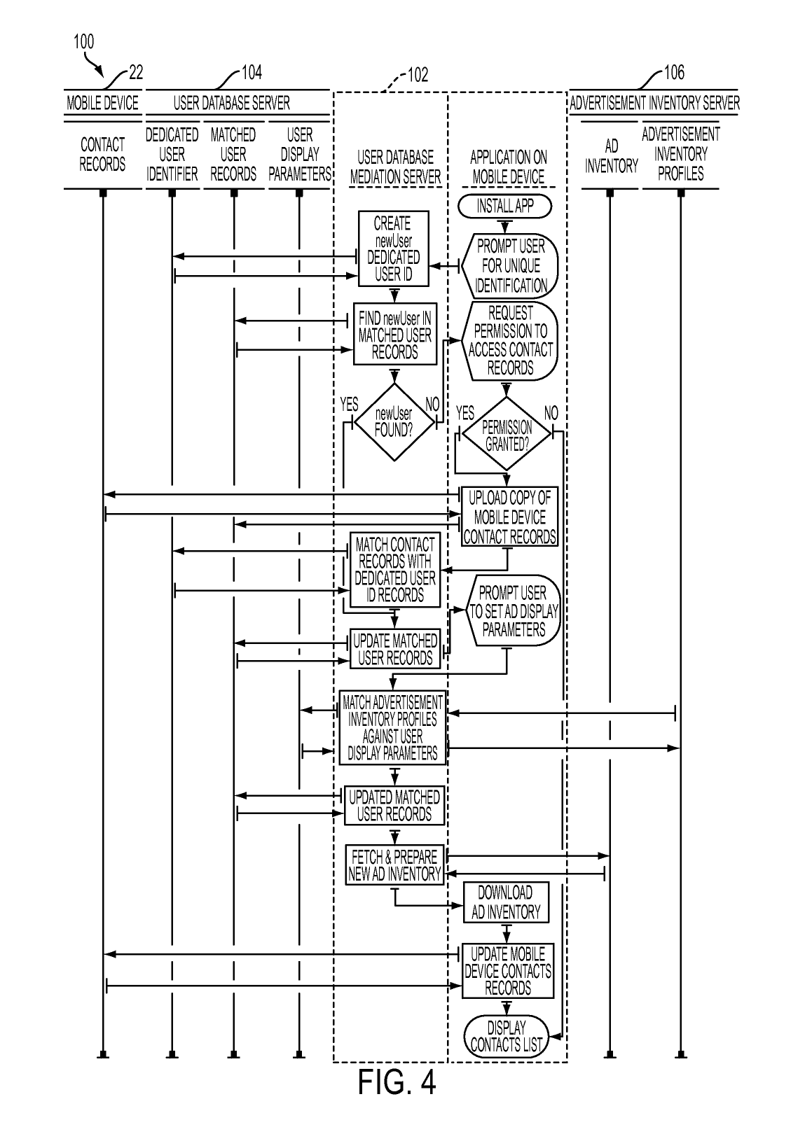

FIG. 4 illustrates an exemplary process for performing initial installation of the app 12 on a user's electronic device 22 and is generally denoted by reference numeral 100. After installing the app 12 on the user's mobile electronic device 22 or other device with mobile networking capabilities, the app may prompt the user to provide identification information, such as an email address, a phone number assigned to a mobile device, or another form of user authentication connected to a mobile device or to a device with mobile networking capabilities. The app 12 may transmit the user's identification information to a User Database Mediation Server (UDBMS) 102, which may create a Dedicated User Identifier (DUID) for the user on an associated User Database Server 104. The UDBMS 102 may then search the User Database Server 104 for the new user's DUID in the records of existing users. If the new user's DUID is found, the UDBMS 102 may update the Matched User Records on the User Database Server 104 to reflect the new connections between the new user and those already existing on the User Database Server.

If the new user's DUID is not found in the User Database Server 104, the app 12 may prompt the user for permission to access the user's Contact Records on the mobile device 22 (i.e., those contact records saved on the user's mobile device) or the device with mobile networking capabilities in order to match the user's Contact Records to the DUID of existing users. In some embodiments, the user may give permission to all, or just some, of the Contact Records. For example, a user may wish to only give access to friends, rather than co-workers. If the user grants the app 12 permission to access the Contact Records on the mobile device 22, the app may upload the user's relevant Contact Records to the UDBMS 102, which will then store those records under the new user's DUID on the User Database Server. The UDBMS 102 may also compare the new user's Contact Records to the DUID records of existing users. The UDBMS 102 may then update the Matched User Records on the User Database Server with the results of the comparison. Unmatched Contact Records may be stored for future comparisons with new users as they sign up for the service. Unmatched Contact Records may be updated automatically whenever matches are found.

After updating the user's Matched User Records on the User Database Server 104, the UDBMS 102 may prompt the user to set his/her preferred advertisement display parameters (such as the user's age, gender, income, interests, etc.). The UDBMS 102 may then update the user's preferred advertisement display parameters with the relevant Matched User Records and compare the display parameters selected by the user to those display terms found in the Advertisement Inventory Profiles on an Advertisement Inventory Server 106. This may be done to ensure that the user receives advertisements to their mobile device that are of interest to him/her, as well as to confirm the delivery of the advertiser's message to the relevant user. The UDBMS 102 may then update the user's Matched User Records with the matched Advertisement Inventory Profile and fetch the relevant Ad Inventory from the Advertisement Inventory Server and prepare them for download based on the operating system and model of the user's mobile device. Finally, the app 12 on the user's mobile device 22 downloads the updated list of contacts and their associated Ad Inventory to the mobile device, updates the user's Contact Records on the mobile device with associated Ad Inventory, and displays the app's Contact List to the user so as to begin using the app.

It is worthwhile to note that while FIG. 4 illustrates the User Database Server, the User Database Mediation Server, and the Advertisement Inventory Server as separate entities, in some embodiments the User Database Server, the User Database Mediation Server, and Advertisement Inventory Server are the same server.

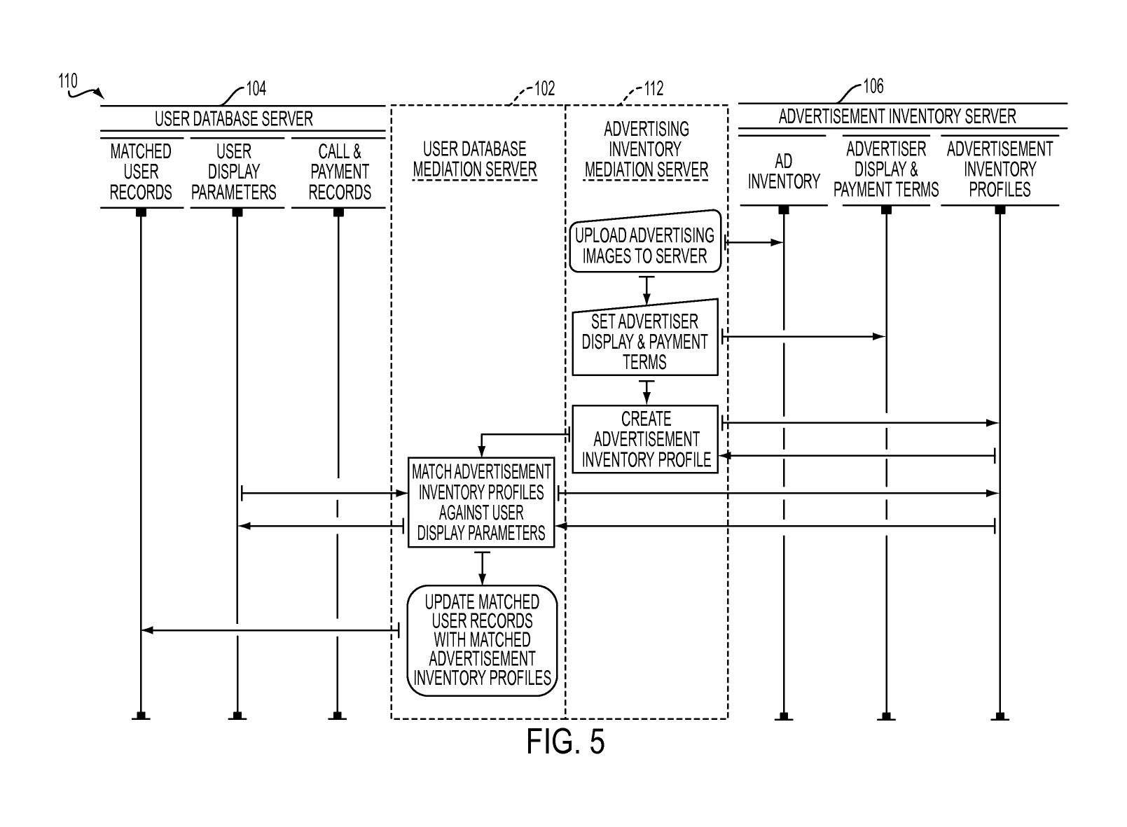

The availability of advertisement inventory is one aspect of the my.ad service. FIG. 5 illustrates an exemplary process for the upload by advertisers of advertisement inventory to the Advertisement Inventory Server 106 and is generally denoted by reference numeral 110. After logging into an Advertisement Inventory Mediation Server (AIMS) 112, advertisers may upload the Ad Inventory that they have prepared for display to my.ad users. For each image uploaded, advertisers may determine the type of users that they would like to view their ad based on parameters such as gender, age and income range, and interests, among other things. The advertisers may also set the payment terms for each Ad Image or set of Ad Inventory, such as the amount to be paid per ad view, the total number of desired views per user, and the duration of the campaign, among other things. Based on the information provided, the AIMS 112 may create an Advertisement Inventory Profile that may then be used by the User Database Mediation Server (UDBMS) 102 to match the desired users to the relevant Ad Inventory. The UDBMS 102 may then update the Matched User Records on the User Database Server with the matching Advertisement Inventory Profiles. The updated Ad Inventory may be downloaded to the users mobile device 22 or a device with mobile networking capability at the next available opportunity.

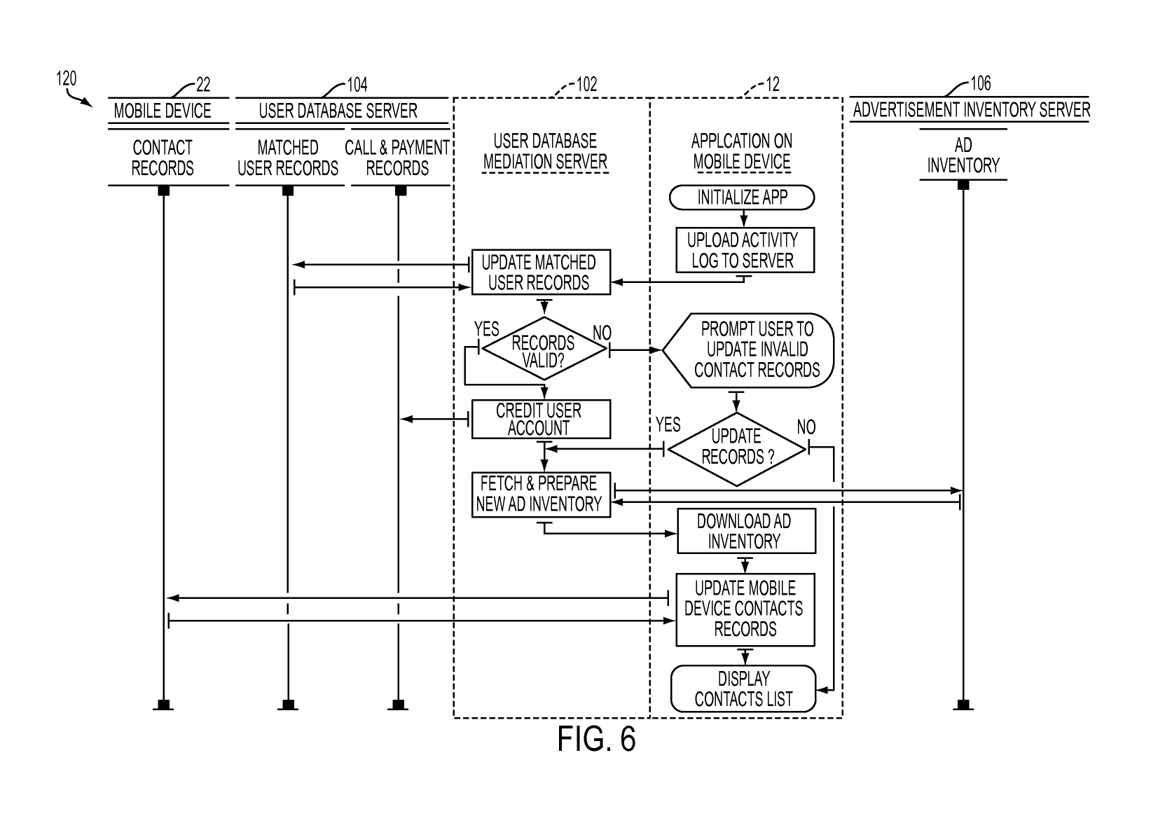

FIG. 6 illustrates an exemplary process for launching the app 12 after it has been initially installed on the electronic device 22 and is generally denoted by reference numeral 120. Upon initialization, the app 12 uploads to the UDBMS 102 the latest Activity Log detailing the calls that the user has completed since the last contact session between the app and the UDBMS. The UDBMS 102 confirms the Activity Log with the Matched User Records on the User Database Server to determine if the Ad Inventory found in the Activity Log is valid (that is, if the inventory in the user's Contact Records is the inventory that was downloaded by the app during the last contact session). If the records are determined to be valid, the UDBMS 102 credits the user's account on the User Database Server according to the Activity Log. If the records are determined to be invalid, the app 12 first prompts the user to update the contact records. If the user agrees to update the records, the app 12 asks the UDBMS 102 to retrieve Ad Inventory from the Advertisement Inventory Server 106. The advertisement inventory server 106 then delivers the advertisements back to the app 12 on the electronic device 22 via the UDBMS 102. The app 12 may then use the retrieved advertisements to update the contact records. If the user declines to update the contact records, the app 12 may upload the invalid contact records list to the UDBMS 102, which matches the invalid list to the user categories. Using this information, the user database server 104 updates the user categories in order for the application to display the contacts list.

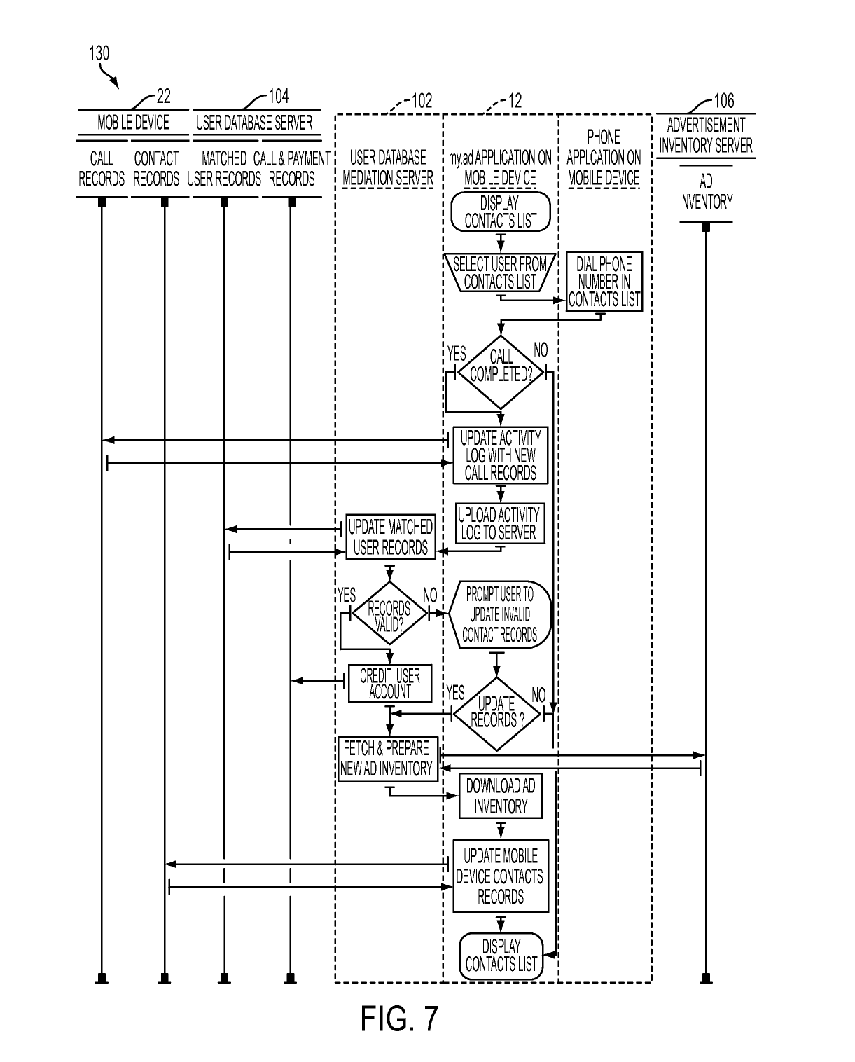

FIG. 7 illustrates an exemplary dialing process for making a call and crediting the user's account for use of the app 12 to display advertisements to contacts and is generally denoted as reference numeral 130. In one embodiment, the user opens the app 12 on the electronic device 22 and selects a contact from his/her contact list. The phone application on the electronic device 22 then dials the number in the contact list. Completion of the call indicates the advertisement was sent to, and viewed by, the receiving user. Accordingly, the app 12 updates an activity log with the completed call record and uploads such activity log to the UDBMS 102, which passes the information to the user database server 104. The user database server 104 may then determine whether the contact record associated with the activity is valid. If yes, the user's account is credited with a predetermined amount and the user's account is updated accordingly. If the user database server 104 determines the contact record to be invalid, the application prompts the user to update the record. The user may then agree to update the record, which will prompt the application to retrieve advertisement inventory to update the contact record.

The electronic device 22 includes various circuitry, including control, input/output, networking and communication circuitry, as well as display, memory and storage devices for carrying out the principles of the present disclosure. The control circuitry, for example, may include any processing circuitry or processing device (e.g., processor) operative to control the operations and performance of the electronic device 22, such as the processes of FIGS. 4-7. For example, control circuitry can be used to run operating system and firmware applications associated with the electronic device. The control circuitry may further provide the platform for receiving user input via a user interface as well as drive the display device and manage the storage and memory devices. The control circuitry may be associated with a special purpose processor or a general purpose processor programmed to execute the process and/or equivalents of such process described above. The my.ad process may also be in the form of computer executable instructions that, when executed by a processor, cause the processor to execute the process.

The computer executable instructions may be stored on one or more computer readable mediums (e.g., RAM, ROM, etc) in whole or in parts. For example, some embodiments of a computer or data processing system may include a processor configured to execute at least one program stored in memory for the purposes of processing data to perform one or more of the techniques that are described herein.

The processor may be coupled to a communication interface, which may include circuitry for connecting with a communication network to thereby send and receive communications (e.g., voice and/or data) from the electronic device to other electronic devices on the communication network. Various suitable communication protocols may be utilized, including Wi-Fi, Bluetooth, near field communication, radio frequencies, infrared, GSM, CDMA, or other suitable protocols.

The input/output circuitry associated with the electronic control device may be provided to convert analog signals and other signals into digital data, or vice versa. The input/output circuitry can receive and convert physical contact inputs (e.g., touch-screen), physical movements (e.g., movement of the device, or via use of a mouse), analog audio signals, or other types of input. Such input/output circuitry may be operatively connected to other electronic components of the electronic device.

The electronic device may include a suitable interface or component for allowing a user to provide inputs to input/output circuitry. For example, input may be facilitated via tactile methods, such as via buttons and/or a touchscreen. Voice commands may also be used to provide the desired input (e.g., “phone Home”). Accordingly, input/output circuitry may be provided in connection with a microphone associated with the electronic device. Moreover, output circuitry for outputting audio (e.g., through speakers) may also be provided. Such speakers may be both integrally connected with the electronic device, but also provided remotely (e.g., through headphones operatively connected to the electronic device).

The input/output circuitry may also include a display interface with associated circuitry for providing a display visible to the user of the electronic device. For example, the display circuitry may be operatively connected to an LCD screen, or other type of display. Furthermore, movable displays or projection systems may also be utilized. In some embodiments, the display circuitry may include a coder/decoder (Codec) to convert digital media data into analog signals. For example, the display circuitry may include video codecs, audio codecs, or any other suitable type of codec.

While various embodiments in accordance with the disclosed principles have been described above, it should be understood that they have been presented by way of example only, and are not limiting. For example, although the processes described above relate to an asynchronous process by which advertisements are first downloaded to a user's address book and then later displayed when such user receives a call from another my.ad user, it is to be appreciated that other embodiments are contemplated in which advertisements are transmitted from one user to another user over a communication network. That is, such transmission of advertisements may be performed synchronously during placement of the call from one user to another user. Thus, the breadth and scope of the invention(s) should not be limited by any of the above-described exemplary embodiments, but should be defined only in accordance with the claims and their equivalents issuing from this disclosure. Furthermore, the above advantages and features are provided in described embodiments, but shall not limit the application of such issued claims to processes and structures accomplishing any or all of the above advantages

What is claimed is:

1. A system for displaying one or more advertisements on an electronic device, comprising:
an application residing on the electronic device the application being adapted to store an advertisement in a contact image record of an address book of the electronic device;
a server disposed remotely from the electronic device, the server being adapted to transmit one or more advertiser-selected advertisements to the contact image record of the electronic device.

2. A system according to claim 1, wherein the electronic device is a mobile device.

3. A system according to claim 1, wherein the electronic device is a device with mobile networking capability.

4. A system according to claim 3, wherein the device with mobile networking capability is a television.

5. A system according to claim 1, further comprising a second electronic device having a second application residing thereon, wherein the second application causes display of the advertisement on an incoming call notification screen of the first electronic device upon receipt of a call from the second electronic device by the first electronic device.

6. A system according to claim 5, wherein the second application is adapted to store an advertisement in a contact image record of an address book of the second electronic device, and wherein the server is adapted to transmit one or more advertiser-selected advertisements to the contact image record of the second electronic device.

7. A system according to claim 6, wherein the first application residing on the first electronic device causes the display of the advertisement on an incoming call notification screen of the second electronic device upon receipt of a call from the first electronic device by the second electronic device.

8. A method for displaying advertisements on an electronic device, comprising:
acquiring permission to automatically display an advertisement on an incoming call notification screen of an electronic device;
transmitting an advertiser-selected advertisement to a contact image record of an address book on the electronic device; and
displaying the advertisement when a call is received from a user associated with the contact image record.

9. A method according to claim 8, further comprising:
displaying one or more contact records on the electronic device;
selecting a contact to call;
initiating a call to the selected contact; and
crediting a user for the call to the selected contact that results in the display of an advertisement on the contact's electronic device.

10. A method according to claim 9, wherein the step of selecting a contact to call and initiating a call are performed in sequence.

11. A method according to claim 9, wherein the step of selecting a contact to call and initiating a call are performed simultaneously.

12. A method according to claim 8, further comprising identifying display parameters and using the display parameters to select advertisements for transmission.

13. A method according to claim 12, further comprising creating one or more advertisement inventory profiles, and wherein the step of using the display parameters to select advertisements for transmission comprises comparing the display parameters to the one or more advertisement inventory profiles.

14. A method according to claim 9, further comprising creating a completed call record and updating an activity log with the completed call record.

15. A method according to claim 14, wherein the step of crediting a user comprises reviewing the activity log and crediting the user according to the number of completed call records in the activity log.

16. A system for transmitting advertisements, comprising:
a user database mediation server for storing preferred advertisement display parameters;
an advertisement inventory server in communication with the user database mediation server, the advertisement inventory server storing advertisement inventory profiles; and
an electronic device in communication with the user database mediation server and the advertisement inventory server, wherein the advertisement inventory server is adapted to transmit advertisements to the electronic device according to a comparison of the preferred advertisement display parameters with the advertisement inventory profiles.

17. A system according to claim 16, further comprising an application residing on the electronic device, the application being adapted to store the advertisements in contact image records of an address book of the electronic device.

18. A system according to claim 16, wherein the electronic device is a mobile phone.

19. A system according to claim 16, wherein the electronic device is a television.
